(19) United States
(12) Patent Application Publication
(10) Pub. No.: US 2023/0175148 A1
(43) Pub. Date: Jun. 8, 2023

(54) SYSTEM FOR PHOTOVOLTAIC ENERGY PRODUCTION AND HYDROGEN GENERATION HAVING A REPEATABLE LAYOUT

(71) Applicant: Ohmium International, Inc., Incline Village, NV (US)

(72) Inventor: Arne Ballantine, Incline Village, NV (US)

(21) Appl. No.: 18/077,082

(22) Filed: Dec. 7, 2022

Related U.S. Application Data
(60) Provisional application No. 63/286,797, filed on Dec. 7, 2021.

(51) Int. Cl. C25B 9/65; H02S 40/32

(52) U.S. Cl. CPC C25B 9/65; H02S 40/32

(57) ABSTRACT

A system for photovoltaic energy production and hydrogen generation having a repeatable layout is described. Photovoltaic panels are arranged in repeating shapes, such as rectangles, triangles, hexagon, other patterns, such that the photovoltaic panels are arranged around hydrogen generation equipment.

This application claims priority to U.S. Provisional Patent Application No. 63/286,797 entitled “LAYOUT TO CREATE A REPEATABLE ELEMENT OF PV RENEWABLE ENERGY WITH ENERGY STORAGE SUCH AS HYDROGEN GENERATION AND STORAGE”, filed Dec. 7, 2021, the entire contents of which are incorporated by reference herein.

### FIELD OF INVENTION

The present invention relates to a system for photovoltaic energy production and hydrogen generation having a repeatable layout

### BACKGROUND

Large scale power installations of the prior art include repeating elements of solar panel installations, lithium-ion battery installations, natural gas, or hydrogen powered fuel cell installations. However, existing large-scale projects do not include a repeatable structure of these elements together for optimum efficiency and lowest installation cost.

### SUMMARY

A system for photovoltaic energy production and hydrogen generation having a repeatable layout is described. Photovoltaic panels are arranged in repeating shapes, such as rectangles, triangles, hexagon, other patterns, such that the photovoltaic panels are arranged around hydrogen generation equipment.

Large scale renewable projects may become more cost effective when construction is very efficient. The system described herein improves efficiency by using repeatable elements for hydrogen generation and solar power production. The system described herein reduces material cost by minimizing a distance between the photovoltaic panels and electrolyzer modules.

In one aspect, a system for photovoltaic energy production and hydrogen generation having a repeatable layout is described. The system includes a plurality of hydrogen generating units. Each hydrogen generating unit includes an electrolyzer module and photovoltaic panels. The photovoltaic panels are arranged or positioned around the electrolyzer module.

### BRIEF DESCRIPTION OF FIGURES

FIG. 1 is a schematic view of the electrolyzer module for the rectangular shaped hydrogen generating unit and system.

FIG. 2 is a schematic view of the electrolyzer module for the triangular shaped hydrogen generating unit and system.

FIG. 3 is a schematic view of the electrolyzer module for the hexagonal shaped hydrogen generating unit and system.

FIG. 4 is a schematic view of the rectangular shaped hydrogen generating unit and system.

FIG. 5 is a schematic view of the triangular shaped hydrogen generating unit and system.

FIG. 6 is a schematic view of the hexagonal shaped hydrogen generating unit and system.

FIG. 7 is a schematic view of the pyramidal shaped support for the photovoltaic panels.

FIG. 8 is a schematic view of the hydrogen generating unit with pyramidal shaped support for the photovoltaic panels.

FIG. 9 is a schematic view of the photovoltaic panels with varied angles of inclination.

FIG. 10 is a schematic view of an array of the photovoltaic panels with varied angles of inclination.

### DETAILED DESCRIPTION

In a system for photovoltaic energy production and hydrogen generation, solar generation equipment captures solar radiation to provide electricity to power hydrogen generation equipment. Typically, the solar generation equipment is more densely provided in a system as compared to the hydrogen generation equipment by a ratio of between about 10 solar panels:1 electrolyzer and about 100 solar panels:1 electrolyzer. As described herein, arrangement of the solar generation equipment concentrically around the hydrogen generation equipment provides a way to radially direct the electricity generated by the solar generation equipment toward the hydrogen generation equipment with the shortest possible runs of expensive copper cable. This reduces material and installation costs for the system.

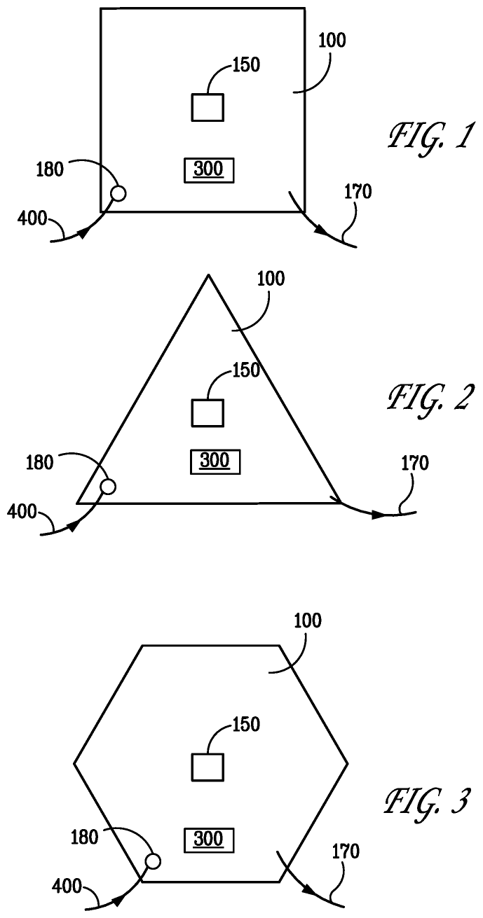

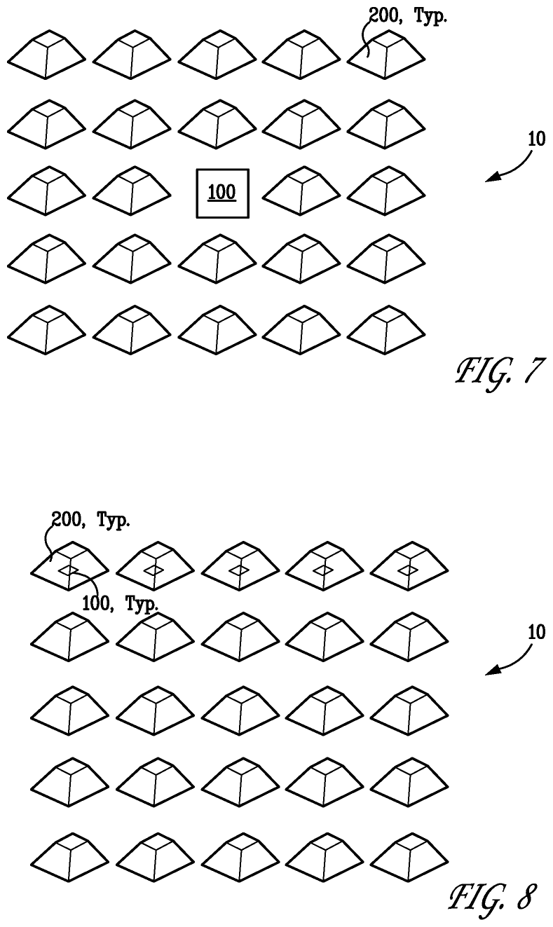

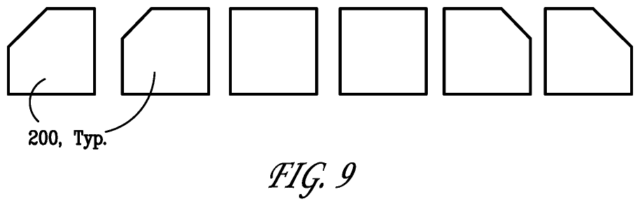

A system 10 for photovoltaic energy production and hydrogen generation having a repeatable layout is described with respect to FIGS. 1-6. Other aspects of the present disclosure are shown in FIGS. 7-10.

The system 10 includes one or more repeating hydrogen generating units 50. Each hydrogen generating unit 50 includes an electrolyzer module 100 and photovoltaic panels 200 are arranged or positioned around the electrolyzer module 100. The system 10 may include two, three, four, five, six, seven, eight or more of the hydrogen generating units 50. Each of the hydrogen generating units 50 in the system 10 may include similar construction. Each hydrogen generating unit 50 is generally similar to another hydrogen generating unit 50 in the system 10.

Each hydrogen generating unit 50 includes the electrolyzer module 100 and one or more photovoltaic panels 200. Typically, each electrolyzer module 100 will be surrounded by a plurality of the photovoltaic panels 200. The number or amount of the photovoltaic panels 200 needed to supply the specific amount of energy to the electrolyzer module 100 may vary depending on the type and style of the photovoltaic panels 200 and the climate, geography, etc. in the area about the photovoltaic panels 200.

The electrolyzer module 100 generates hydrogen gas through electrolysis. The electrolyzer module 100 is generally supplied with electricity generally from the photovoltaic panels 200. The electrolyzer module 100 may typically include an electrochemical stack into which electricity may be directed to form hydrogen and oxygen from water using electrolysis. The electrolyzer modules 100 split the water supplied to the electrolyzer module 100 via electrolysis to form hydrogen and oxygen. Suitable electrolyzer modules 100 are described in U.S. Patent Publications 2021/0156038 and 2021/0156039 to Ohmium, Inc., the entire contents of which are incorporated by reference herein.

The electrolyzer module 100 may further comprise power electronics 300. The power electronics 300 may be formed or provided in a single assembly that connects input energy from the photovoltaic panels 200, the electrolyzer stack, and/or additional energy outputs or energy loads. The power electronics 300 may be operable to connect to DC energy inputs, AC energy inputs, and combinations thereof. The power electronics 300 may further be operable to connect to DC energy loads, AC energy loads, and combinations thereof. Further, the power electronics 300 may allow for direct delivery of energy inputs to the energy loads in parallel with the operation of the energy storing electricity generator during times when those energy input sources are available. This is particularly useful when the energy inputs comprise intermittent energy sources. The power electronics 300 may comprise a GaN inverter board, an integrated power board, control cards, a display board, and/or a DAB converter, one or more transformers, one or more rectifiers, etc.

The electrolyzer module 100 includes a fluidic connection 180 that is fluidically connectable to the water supply 400. The water supply 400 may include purified water, tap water, or another water source. The electrolyzer module 100 is preferably fluidly connected to the water supply 400.

The photovoltaic panels 200 may be arranged or positioned around the electrolyzer module 100. The photovoltaic panels 200 may be arranged or positioned to surround the electrolyzer module 100 to reduce an amount of wiring needed to electrically connect the photovoltaic panels 200 and the electrolyzer module 100. For example, the photovoltaic panels 200 may be arranged concentrically around the electrolyzer module 100. The photovoltaic panels 200 may be arranged in repeating shapes and/or repeating nested shapes.

In certain aspects, the photovoltaic panels 200 of each hydrogen unit 50 of a plurality of hydrogen generating units 50 in the system 10 are arranged in a pattern around their respective electrolyzer module 100, and the hydrogen generating units 50 in the system 10 are arranged in the same pattern. For example, the photovoltaic panels 200 of each hydrogen unit 50 of a plurality of hydrogen generating units 50 in the system 10 may be arranged in a rectangular, square, triangular, hexagonal pattern around their respective electrolyzer module 100, and the respective hydrogen generating units 50 in the system 10 may be arranged in the same rectangular, square, triangular, hexagonal, or other pattern. In certain aspects, the system 10 may include partial or fractional rectangular, square, triangular, hexagonal, or other patterns of hydrogen generating units 50 to accommodate an installation site's geography, size, location, power needs, etc.

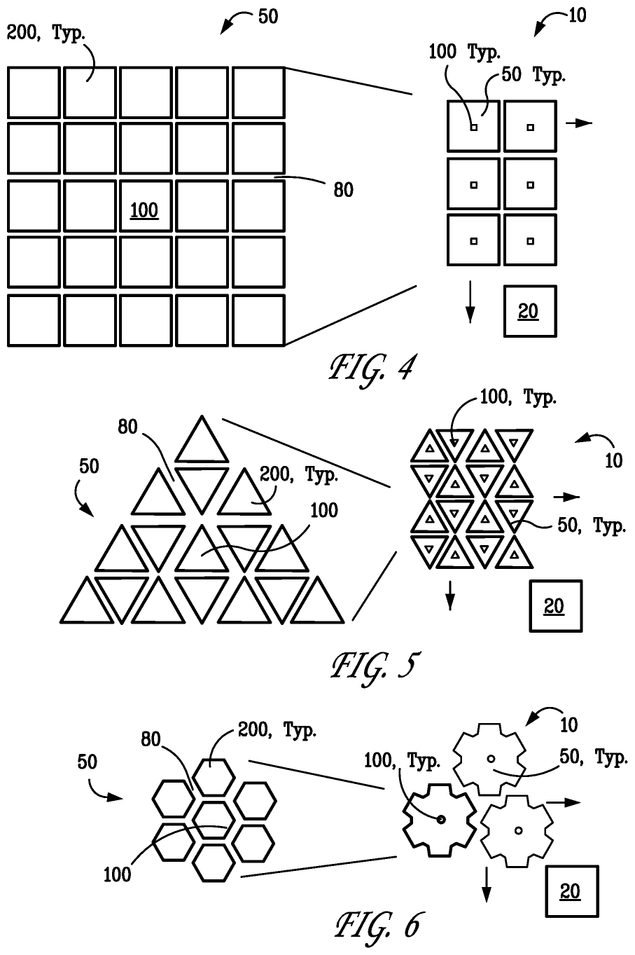

FIG. 1 is a schematic view of the electrolyzer module 100 for the rectangular shaped hydrogen generating unit 50 and the system 10. FIG. 2 is a schematic view of the electrolyzer module 100 for the triangular shaped hydrogen generating unit 50 and system 10. FIG. 3 is a schematic view of the electrolyzer module 100 for the hexagonal shaped hydrogen generating unit 50 and system 10. Of course, depending upon the installation site, the pattern may be only partially or fractionally repeated. As the space required ratio of solar generation to hydrogen generation increases, additional full or partial rings of photovoltaic panels 200 may be placed concentrically around the electrolyzer module 100 thereby increasing the total ratio of solar panels 200 to electrolyzer modules 100.

In certain aspects, the system 10 may include a support structure or housing that positions the photovoltaic panels 200 with an angled bias to provide enhancing the inclination toward the sun without the need for a tracker. For example, the support structure may position some of the photovoltaic panels 200 at a first angle of inclination, while the support structure may position other of the photovoltaic panels 200 at a second angle of inclination.

In certain aspects, such as shown in FIG. 7, the photovoltaic panels 200 are provided on a pyramidal shaped support. The photovoltaic panels 200 may be mounted on the sides of the pyramidal shaped support. This angles the different photovoltaic panels 200 on the support at different points such that the capture of solar radiation is optimized. In certain aspects, such as shown in FIG. 8, the photovoltaic panels 200 are provided on a pyramidal shaped support that also houses the electrolyzer module 100.

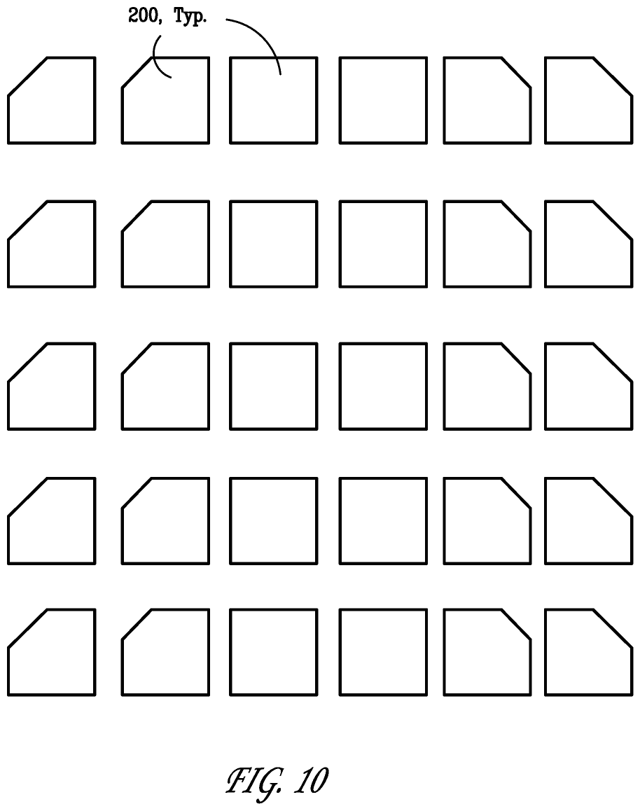

In certain aspects, individual photovoltaic panels 200 in the hydrogen generating unit 50 are angled at different points such that the capture of solar radiation is optimized. With respect to FIG. 9, the photovoltaic panels 200 include three different angles of inclination; however, those having ordinary skill in the art will appreciate that more or fewer angles of inclination may be used. For example, the photovoltaic panels 200 may include one, two, three, four, five, six, or more angles of inclination. The photovoltaic panels 200 of FIG. 9 are installed in a stationary position. As shown in FIG. 10, an array of such photovoltaic panels 200 may be formed.

Further, the photovoltaic panels 200 in a particular hydrogen generating unit 50 may be angled at different points. For example, in a hydrogen generating unit 50 with 24 different photovoltaic panels 200, portions of the 24 different photovoltaic panels 200 may be angled differently than a remainder of the 24 photovoltaic panels 200. For example, photovoltaic panels 1-6 may angle toward point A, photovoltaic panels 7-12 may angle toward point B, photovoltaic panels 13-18 may angle toward point C, and photovoltaic panels 19-24 may angle toward point D.

In certain aspects, the system 10 may include trackers that movably position the photovoltaic panels 200 with an angled bias to enhance the inclination toward the sun. The trackers may adjust the position of the photovoltaic panels 200 depending on time of day, month, season, weather, etc.

The system 10 preferably provides efficient worker or vehicle access between the repeating hydrogen generating units 50, as rectangle, triangle or hexagon shaped repeating hydrogen generating units 50 repeat well without wasted space and with boundary areas available for maintenance access. The system may include access paths 80 between the respective units 50. The access paths 80 may form generally straight passageways or paths between the respective units 50. The access paths 80 may include a sufficient width, such that individuals may walk-on or vehicles may drive on the access paths 80. For example, with respect, to FIG. 2, an access path 80 passes directly by three or more units 50. In other systems 10, the access paths 80 may pass directly by additional hydrogen generating units 50. The hydrogen generating units 50 may be arranged such that controls, electrical panels, and electrical connections are accessible from the access paths 80.

In certain aspects, the photovoltaic panels 200 are in electrical communication with a DC/DC rectifier to condition the power supplied to the electrolyzer module 100 and to the other electrically operated system components. In certain aspects, the electrolyzer module 100 is in electrical communication with a DC/DC bus.

In an aspect, each hydrogen generating unit 50 includes a local electronic control unit 150 that monitors or controls the electrolyzer module 100 and the photovoltaic panels 200 of the specific unit 50. The local electronic control unit 150 may monitor the generation of the electricity by the electrolyzer module 100. The local electronic control unit 150 may monitor solar conditions and direct the operation of the electrolyzer module 100 as required. The local electronic control unit 150 may direct and modulate the transfer of electricity to the electrolyzer module 100. Each hydrogen generating unit 50 may further include switchgears and disconnects.

In another aspect, the system 10 may include a site controller 20 that interconnects and communicates with all of the local electronic control units 150 of the units 50. The site controller 20 monitors the hydrogen production of the system 10. The site controller 20 may be interconnected and/or directed by a remote operator, connected to the main computer system of the operator of the system 10, etc. The system 10 may be controlled and directed via remote operation.

The system 10 provides water to each hydrogen generating unit 50 for electrolysis. The system 10 may connected to municipal water supplies, wells, reservoirs, or other water collection systems. Rainwater, run-off, or other sources of water may used with the system 10. The system 10 may include tanks, regulators, pumps, in fluidic communication with the water supply 400 in fluidic communication with the hydrogen generating unit 50 to supply the hydrogen generating unit 50. The system 10 may include one or more water purifiers, filters, water conditioners, etc. to locally purify the water and deliver the water to electrolyzer modules 100. The water supply 400 may include tanks, regulators, pumps, reservoirs, etc. in fluidic communication with the water supply 400 to ensure a sufficient flow of water through the water supply 400. The water supply 400 may include piping, conduits, hosing, tubing, etc. suitable for the transfer of water. The water supply 400 may branch into one or more sub-lines to supply multiple hydrogen generating units 50 with water.

The system 10 generally includes the photovoltaic panels 200 as a power source. In other aspects, the system 10 may include the photovoltaic panels 200 and a back-up or supplemental power source, such as a municipal electric grid, regional electric grid, private electric grid, etc. The electrolyzer module 100 may additionally be electrically connected to such sources. The grids may include renewable energy sources (solar, wind, geothermal, hydroelectric, hydrogen fuel cells) and/or non-renewable energy sources (coal, natural gas). The system 10 may include combination of such sources. For example, the photovoltaic panels 200 may be backed up and/or supplemented by other energy sources or supplies, as needed. Further, the power source may include electrical storage, such as batteries, to store energy for use in the system 10.

The system 10 may also electrically connect to a separate electrical storage system. The electrical storage system may be in electrical communication with the at least one photovoltaic panel 200 and may be capable of storing electrical energy produced by the at least one photovoltaic panel 200 when an excess of energy is produced. The electrical storage system may also be in electrical communication with other energy sources, including renewable energy sources, non-renewable energy sources, a municipal power grid, a regional power grid, etc. The electrical storage system may supply electrical power to the system 10 as needed. When the electrolyzer module 100 is not running or if there is an over-production of electricity from the photovoltaic panels 200, the excess electricity generated by the at least one photovoltaic panel 200 may be stored in an electricity storage system. The electricity storage system may include any system for storing electricity known in the art. For example, the electricity storage system may include one or more batteries, such as lithium-ion batteries.

The hydrogen generating units 50 include a hydrogen gas output 170. The hydrogen gas outputs 170 may fluidically connect with a main gas output line for the system 10. The hydrogen gas outputs 170 may fluidically connect with storage tanks and vessels. The hydrogen gas outputs 170 may fluidically connect with and supply hydrogen gas refueling stations.

As used herein, a “fluid” connection is a connection that allows for or facilitates the transfer of fluids including liquids and gases. Non-limiting examples of fluid connections include pipes, manifolds, ducts, valves, hoses, couplings, tubes, etc.

As used herein, an “electrical” connection is a connection that allows for or facilitates the transfer of electricity. Non-limiting examples of electrical connections include wires, cables, power lines, breakers, transformers, converters, rectifiers, switches, etc.

As used herein, an “operable” connection includes any connection that allows for or facilitates the operation of a system unit or process. An operable connection may include an electrical connection and/or a fluid connection.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A system for photovoltaic energy production and hydrogen generation having a repeatable layout, comprising:
a plurality of hydrogen generating units;
wherein each hydrogen generating unit comprises:
an electrolyzer module; and
photovoltaic panels, the electrolyzer module electrically connectable to the photovoltaic panels, wherein the photovoltaic panels are arranged or positioned around the electrolyzer module.

2. The system according to claim 1, wherein the photovoltaic panels are arranged concentrically around the electrolyzer module.

3. The system according to claim 1, wherein each hydrogen generating unit of the plurality of hydrogen generating units is generally similar to other hydrogen generating units of the plurality of hydrogen generating units.

4. The system according to claim 1, wherein the plurality of hydrogen generating units comprises a first hydrogen generating unit and a second hydrogen generating unit, wherein the photovoltaic panels of the first hydrogen unit are arranged in a same pattern as photovoltaic panels of the second hydrogen unit.

5. The system according to claim 1, wherein the photovoltaic panels of each hydrogen unit of the plurality of hydrogen generating units are arranged in a pattern around the electrolyzer module, wherein the plurality of hydrogen generating units in the system are arranged in the same pattern.

6. The system according to claim 1, wherein the photovoltaic panels of each hydrogen unit of the plurality of hydrogen generating units are arranged in a rectangle, square, triangle or hexagon shaped pattern around the electrolyzer module, wherein the plurality of hydrogen generating units in the system are arranged in the same pattern.

7. The system according to claim 1, wherein the hydrogen generating units of the plurality of hydrogen generating units are arranged in a repeating rectangle, square, triangle or hexagon shaped pattern.

8. The system according to claim 1, wherein each electrolyzer module includes a power electronic system that is electrically connectable to the photovoltaic panels.

9. The system according to claim 1, wherein each electrolyzer module includes a fluidic connection that is fluidically connectable to a water supply.

10. The system according to claim 1, wherein access paths are formed between the plurality of hydrogen generating units.

11. The system according to claim 10, wherein the access paths form generally straight passageways or paths between the plurality of hydrogen generating units.

12. The system according to claim 10, The system according to claim 10, wherein the access paths pass directly by the plurality of hydrogen generating units.

13. The system according to claim 1, wherein the photovoltaic panels have a varying angle of inclination.

14. The system according to claim 1, wherein the photovoltaic panels are arranged in a pyramidical shape.

15. The system according to claim 1, wherein the photovoltaic panels in a hydrogen generating unit of the plurality of hydrogen generating units have a varying angle of inclination.

16. A system for photovoltaic energy production and hydrogen generation having a repeatable layout, comprising:
a first hydrogen generating unit comprising:
a first electrolyzer module;
a first set of photovoltaic panels, wherein the first set of photovoltaic panels are arranged or positioned around the first electrolyzer module, the first electrolyzer module electrically connectable to the first set of photovoltaic panels;
a second hydrogen generating unit comprising:
a second electrolyzer module;
a second set of photovoltaic panels, wherein the second set of photovoltaic panels are arranged or positioned around the second electrolyzer module; the second electrolyzer module electrically connectable to the second set of photovoltaic panels.

17. The system according to claim 16, wherein the first hydrogen generating unit is generally similar to the second hydrogen generating unit.

18. The system according to claim 16, further comprising a third hydrogen generating unit comprising:
a third electrolyzer module; and
a third set of photovoltaic panels, wherein the third set of photovoltaic panels are arranged or positioned around the third electrolyzer module; the third electrolyzer module electrically connectable to the third set of photovoltaic panels.

19. The system according to claim 18, wherein the third hydrogen generating unit is generally similar to the first and second hydrogen generating units.

20. A system for photovoltaic energy production and hydrogen generation having a repeatable layout, comprising:
a plurality of hydrogen generating units;
wherein each hydrogen generating unit comprises:
an electrolyzer module;
photovoltaic panels, the electrolyzer module electrically connectable to the photovoltaic panels, wherein the photovoltaic panels are arranged or positioned concentrically around the electrolyzer module; and
wherein the photovoltaic panels of each hydrogen unit of the plurality of hydrogen generating units are arranged in a rectangle, square, triangle or hexagon shaped pattern around the electrolyzer module, wherein the plurality of hydrogen generating units in the system are arranged in the same rectangle, square, triangle or hexagon shaped pattern.
